(19) United States
(12) Patent Application Publication
(10) Pub. No.: US 2024/0139960 A1
(43) Pub. Date: May 2, 2024

(54) ROBOTIC ARM IN-VEHICLE OBJECT DETECTION

(71) Applicant: GM Cruise Holdings LLC, San Francisco, CA (US)

(72) Inventors: Mark Liu, New York, NY (US); Haggai Nuchi, San Francisco, CA (US); Yung-Chang Ko, San Francisco, CA (US)

(21) Appl. No.: 17/978,040

(22) Filed: Oct. 31, 2022

(51) Int. Cl. B25J 9/16; B25J 11/00; B25J 13/08; B60S 3/00

(52) U.S. Cl. CPC B25J 9/1697; B25J 9/163; B25J 9/1653; B25J 9/1679; B25J 11/0085; B25J 13/089; B60S 3/008

(57) ABSTRACT

The disclosed technology provides solutions for facilitating automated cleaning of an autonomous vehicle (AV) and in particular, for identifying objects and maintenance areas within an AV cabin. A process of the disclosed technology can include steps for collecting sensor data representing a cabin of an autonomous vehicle (AV) using an optical sensor disposed on a robotic arm, identifying one or more objects represented by the sensor data, and determining if the cabin of the AV can be cleaned using one or more tools associated with the robotic arm based on an identification of at least one of the one or more objects. Systems and machine-readable media are also provided.

### BACKGROUND

### 1. Technical Field

The disclosed technology provides solutions for facilitating automated cleaning of an autonomous vehicle (AV) and in particular, for identifying objects and maintenance areas within an AV cabin.

### 2. Introduction

Autonomous vehicles (AVs) are vehicles having computers and control systems that perform driving and navigation tasks that are conventionally performed by a human driver. As AV technologies continue to advance, they will be increasingly used to improve transportation efficiency and safety. As such, AVs will need to perform many of the functions that are conventionally performed by human drivers, such as performing navigation and routing tasks necessary to provide a safe and efficient transportation. Such tasks may require the collection and processing of large quantities of data using various sensor types, including but not limited to cameras and/or Light Detection and Ranging (LiDAR) sensors disposed on the AV.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the subject technology. In the drawings:

FIGS. 1A and 1B respectively illustrate side and front perspective views of an autonomous vehicle (AV) positioned adjacent to a gantry that is configured to support one or more robotic arms, according to some aspects of the disclosed technology.

FIG. 2 conceptually illustrates a block diagram of an example system for localizing a robotic arm, actuating one or more tools on the arm and performing object identification, according to some aspects of the disclosed technology.

FIG. 3 illustrates a flow diagram of an example process for localizing a robotic arm within an AV cabin, according to some aspects of the disclosed technology.

FIG. 4 illustrates a flow diagram of an example workflow for servicing an AV, according to some aspects of the disclosed technology.

FIG. 5 illustrates a flow diagram of an example process for determining if an AV cabin can be cleaned using work tools of a robotic arm, according to some aspects of the disclosed technology.

FIG. 6 illustrates an example output of an image classification machine-learning model, according to some aspects of the disclosed technology.

FIG. 7 illustrates an example machine-learning architecture that can be used for performing image classification, according to some aspects of the disclosed technology.

FIG. 8 illustrates an example system environment that can be used to facilitate AV dispatch and operations, according to some aspects of the disclosed technology.

FIG. 9 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring certain concepts.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Many routine vehicle maintenance tasks, such as the cleaning of external and internal surface of a vehicle are typically performed by human operators. For autonomous vehicle deployments it would be advantageous to automate certain maintenance tasks, such as cabin cleaning, to improve maintenance efficiencies, especially in instances where multiple vehicles are used, such as in AV fleet deployments.

Aspects of the disclosed technology provide solutions for automating AV maintenance using a robotic arm that is configured to perform work on various surfaces (e.g., seats, floors, etc.) of an AV. Some aspects of the instant disclosure provide solutions for precisely localizing the robotic arm to facilitate entry of the arm into an AV cabin, and for localizing the robotic arm within the AV cabin, e.g., to facilitate the performance of work within the cabin. Many of the examples discussed herein relate to the performance of cleaning tasks using one or more tools disposed on the AV (e.g., to perform vacuuming, spraying, and/or wiping etc.). However, it is understood that the localization solutions disclosed herein can be applied to other use cases and that the performance of other tasks using a robotic arm are contemplated, without departing from the scope of the disclosed technology.

In some aspects, a robotic arm can be positioned adjacent to an AV for which work is to be performed. For example, a robotic arm may be mounted to a gantry or other structure to facilitate movement and positioning of the arm. The robotic arm can include various sensors configured to collect data to facilitate arm localization, as well as one or more tools configured to perform various types of work, including but not limited to: the actuation of door handles, vacuuming, spraying, wiping and/or disinfecting, etc.

In operation, a robotic arm can be precisely positioned and actuated using a localization and control system to position the arm, as well as to actuate various tools mounted to the arm. For example, localization and manipulation of a robotic arm may be performed by comparing sensor data representing various AV features to a priori models for similar AV configurations. In other aspects, localization and manipulation of the robotic arm may be performed without the use of a priori models, for example, by using machine-learning approaches identify features of the environment (e.g., on various AV surfaces), and to alter a position or pose of the arm in relation to the AV based on the identified features. Further details regarding robotic arm localization are discussed in further detail below.

Additionally, aspects of the subject disclosure provide solutions for identifying objects based on sensor data collected by one or more sensors on the robotic arm. Object classification can be used to determine where cleaning or other work should (and should not) be performed within the AV cabin. Additionally, object identification/classification can be used to determine when additional maintenance or outside human intervention may be required, such as when valuables have been left in the AV, and/or when detected maintenance/cleaning issues fall outside the scope or capability of work that can be performed using robotic arm tools. In such instances, workflow processes can be triggered, e.g., to insure that the AV is routed to the proper facility or that necessary personnel are alerted to handle necessary maintenance tasks.

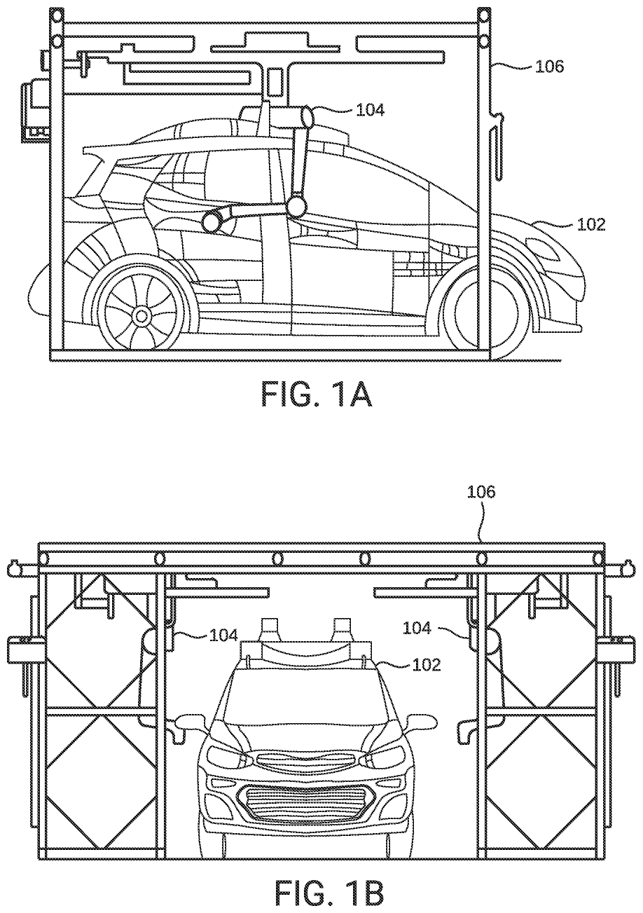

FIGS. 1A and 1B respectively illustrate side and front perspective views of an autonomous vehicle (AV) positioned adjacent to a gantry that is configured to support one or more robotic arms. In operation, AV 102 can be configured to park next to robotic arm 104, under (or adjacent to) gantry 106. However, in other configurations, robotic arm 104 may be mounted to another structure, such as a stand or floor-mounted rail, etc.

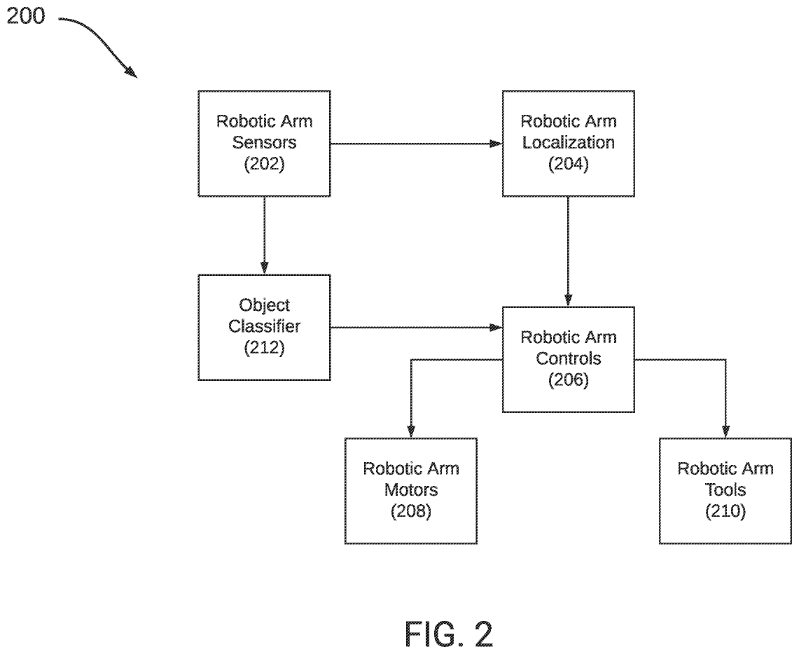

Depending on the desired implementation, two or more robotic arms 104 may be mounted to gantry 106, and configured to perform work on AV 102, e.g., as illustrated in FIG. 1B. In the example of FIGS. 1A and 1B, robotic arm 104 is mounted to gantry 106 at a proximal-end or base that can be positioned at different locations along gantry 106, e.g., to move robotic arm 104 into a position that facilitates entry into the cabin of AV 102. Positioning of robotic arm 104 with respect to gantry 106 can be facilitated using a control system configured for manipulating and operating robotic arm 104, as discussed in further detail below with respect to FIG. 2.

FIG. 2 conceptually illustrates a block diagram of an example system 200 for localizing a robotic arm and actuating one or more tools thereon. System 200 includes one or more robotic arm sensors 202 that are communicatively coupled with and configured to provide sensor data to a localization module 204, as well an object classifier 212. In turn, localization module 204 is coupled to controls module 206 that is configured to control actuation of various arm motors 208, and arm tools 210 associated with the robotic arm. Robotic arm controls module 206 is also configured to receive inputs from object classifier 212, for example, to facilitate the identification of objects and/or AV cabin areas where work is to performed or avoided.

Sensors 202 can include various types of optical sensors (e.g., cameras, LiDARs, etc.) that can be configured to collect sensor data relating to an environment around a robotic arm, such as robotic arm 104, discussed above. For example, sensors 202 may include one or more infrared cameras, such as a stereo infrared camera to collect point cloud data about the surrounding environment. Sensors 202 can also be configured to produce depth-map images (e.g., using one or more LiDAR) sensors to detect/identify various AV features, such as external surfaces (doors and/or door handles), as well as internal features, such as seat surfaces or objects located in the AV cabin, as discussed in further detail below. Depending on the desired implementation, sensors 202 may be mounted to an armature of the robotic arm, such as mounted to an end-effector located at a distal end of the robotic arm. Data collected by sensors 202 can be provided to localization module 204 to determine a relative location of the robotic arm with respect to the surrounding environment, such as with respect to an AV, e.g., AV 102 discussed above. Additionally, data collected by sensors 202 can be provided to object classifier 212, which can be configured to facilitate the identification of one or more objects represented in the collected sensor data.

Using localization module 204, collected sensor data (e.g., point cloud data) representing an AV can be compared to an internal (a priori) model of the AV's features/geometry to identify a location of one or more AV features. For example, point cloud data collected by a stereo infrared camera may be compared to an a priori model of an AV to identify a location of one or more doors and/or door handles. Depending on the desired implementation, comparisons of point cloud data, such as the comparison of sensor data collected by sensors 202 with a pre-existing point cloud model, may be performed using an Iterative Closest Point (ICP) algorithm. Such comparisons can be used to identify pose differences between collected sensor data and preexisting models to determine a location and/or orientation/pose of the arm and/or associated tools with respect to features in the environment. It is contemplated that other algorithms may be used to process point cloud comparisons, without departing from the scope of the disclosed technology.

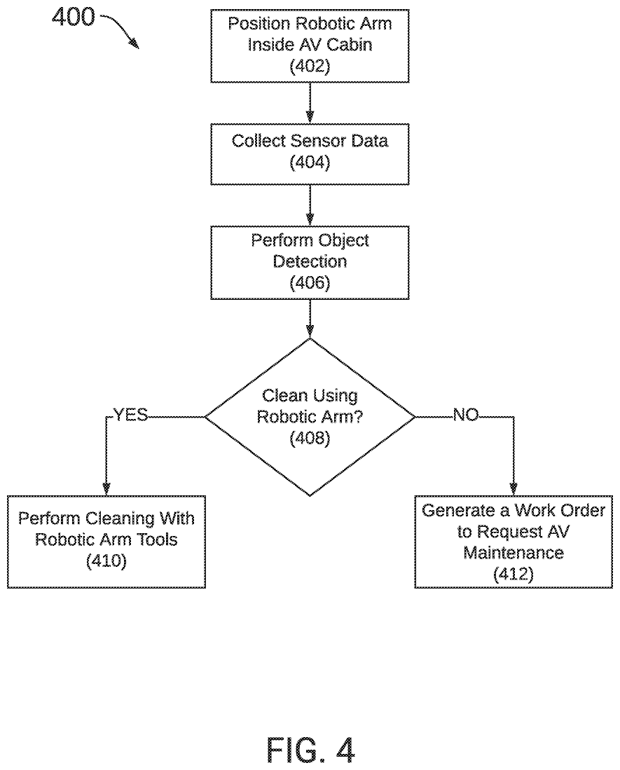

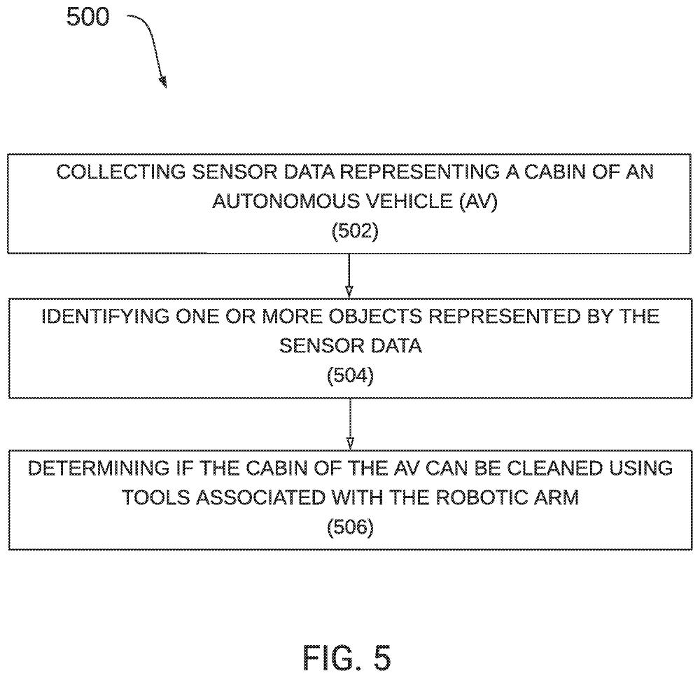

In some approaches, localization and motion planning for the robotic arm may be performed without the use of a priori point cloud models. In such instances, collected sensor data representing the environment in which the robotic arm is navigating (e.g., outside of the AV, or inside the AV cabin) can be provided to a machine-learning model, such as one or more machine-learning models in object classifier 212, that can be used to perform feature identification. For example, machine learning models may be used to process ingested sensor data and to identify (or classify) salient features of the AV, such as doors, door handles, seats etc., in order to manipulate the robotic arm. Object classifier 212 can also be used to identify and semantically label objects in the AV cabin, such as articles and other miscellaneous remainders that may have been inadvertently left or discarded on the seats or floors of the cabin. As discussed in further detail below with respect to FIGS. 4 and 5, object classifier 212 may also be used to identify/classify areas of the AV cabin that need maintenance, such as by identifying moisture, spills and/or other debris, and additionally identifying the type of work that may be required to perform the corresponding maintenance.

Irrespective of the localization approach used, movement of the robotic arm and actuation of various tools disposed thereon can be facilitated using a robotic arm controls module 206 that is configured to control various motors 208 and/or associated tools 210. By way of example, controls module 206 can be used to operate/actuate motor-controlled joints or pivots of the robotic arm, thereby controlling a location and pose of the arm and/or associated tools. Additionally, controls module 206 can be used to operate various tools attached to an end-effector at the distal end of the robotic arm, or at other locations on the arm.

In operation, using sensor data collected by sensors 202, localization module 204 can perform operations for identifying an AV door handle, such as a door handle on AV 102, discussed above. Localization of a given feature, like the door handle, can be useful for downstream (subsequent) localizations, since a salient feature of the vehicle has been identified. For localization processes performed using the ICP algorithm, protruding features (such as door handles) may be more easily (or accurately) localized as compared to flush/flat AV surfaces, such as door panels or windows, etc.

Once the door handle has been accurately located, controls module 206 can be used to operate an end-effector and/or other tools to engage with and actuate the door handle, e.g., to open an associated door of the AV. Once access to the AV cabin is made available (via the open door), the arm can be navigated to an interior of the AV cabin and localization within the cabin environment can be performed to orient the arm, as well as the associated tools, with various features, surfaces, and/or objects located therein. Localization within the AV cabin can be performed by first modeling interior surfaces and features of the AV using multiple sets of image data (e.g., multiple images) to develop accurate representations of various AV surfaces, features, and other objects located inside the AV. By way of example, multiple correlated (or stitched) infrared images may be used to eliminate noise in the collected sensor data and to generate high-accuracy representations of various features in the cabin.

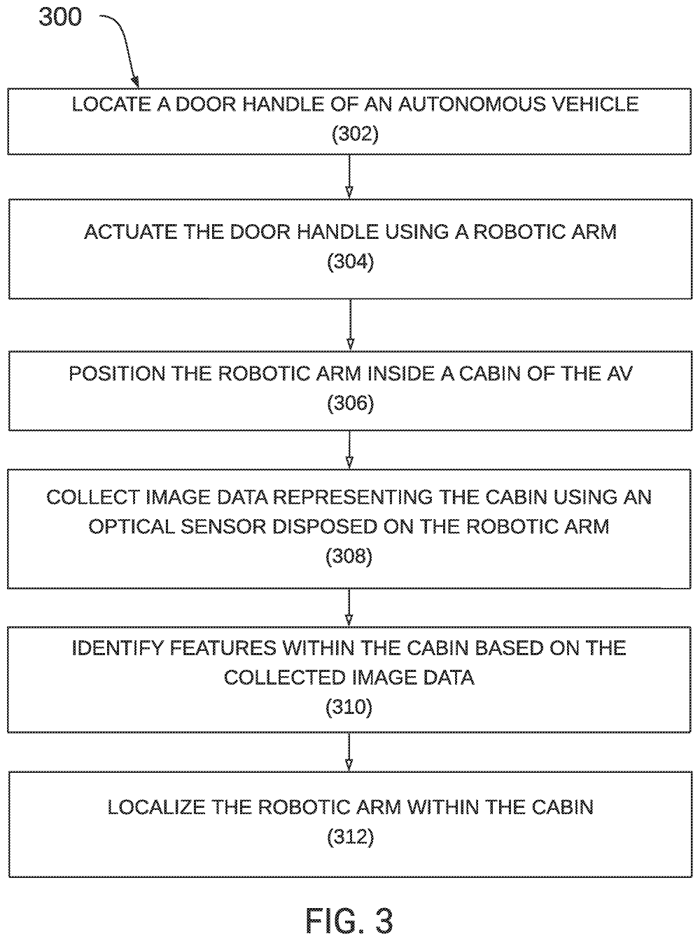

Using an understanding of the various features within the cabin, tools on the arm can be used to perform cleaning-related tasks, such as vacuuming seats or floors, spraying cleaners or other disinfectants, and/or for removing items, such as trash or other debris from the cabin interior. Further details relating to a process for maneuvering a robotic arm into an AV cabin and performing various work-tasks are discussed in relation to FIGS. 3-5, below.

FIG. 3 illustrates a flow diagram of an example process 300 for localizing a robotic arm within an AV cabin, according to some aspects of the disclosed technology. At step 302, process 300 includes locating a door handle of an autonomous vehicle (AV). As discussed above, identifying a location of the door handle (or any other feature) can be performed based on sensor data collected by one or more sensors, such as one or more optical sensors mounted to a robotic arm, as discussed above with respect to FIGS. 1A/1B and FIG. 2. By way of example, the collected sensor data may include camera image data representing an exterior surface of the AV e.g., including one or more doors and/or door handles, that has been captured by an infrared stereo camera. Feature identification/location can also be performed using other types of sensor data, such as LiDAR sensor data, etc.

Localization of the robotic arm can be performed using one or more internal (a priori) models representing various AV structures. Depending on the desired implementation, various internal models may be associated with AVs on a model-by-model basis, or on a vehicle-by-vehicle basis. For example, the selection or lookup of a priori models may be based on information identifying a type of vehicle to be serviced (e.g., by model or vehicle name), and/or based on a unique vehicle identifier e.g., a Vehicle Identification Number (VIN).

Collected sensor data, such as stereo-infrared image data, can be used for comparison with a corresponding model to determine a location/pose of the arm with respect to the AV. By way of example, an ICP algorithm may be used to compare collected point cloud sensor data with the requisite internal mode to determine differences, and thereby to determine movements necessary to properly position the robotic arm for a desired task, such as actuating a door handle.

At step 304, process 300 includes actuating the door handle, using a robotic arm to open a door of the AV. Actuation of the door handle can be performed using a tool mounted on, or disposed at, a distal end of the robotic arm. By way of example, a tool attached to an end-effector of the robotic arm can be used to engage with and actuate the door handle and to open the door, thereby permitting entry of the arm into the AV cabin.

At step 306, process 300 includes positioning the robotic arm inside a cabin of the AV. Positioning (or re-positioning) of the robotic arm can be accomplished by actuating one or more motors in joints of the robotic arm and or the end-effector, e.g., via a control module, such as robotic arm controls module 206, discussed above. Additionally, movement of the arm may be facilitated by positioning, or re-positioning the robotic arm with respect to the gantry. That is, a movable base at the proximal end of the arm, which couples to the gantry, may be movably positioned so that the arm may be driven into the AV cabin.

At step 308, process 300 includes collecting sensor data (e.g., image data) representing the cabin (and any objects inside the cabin) using an optical sensor disposed on a distal end of the robotic arm. Depending on the desired implementation, the image data can be collected by various camera sensors, such as a stereo infrared (IR) camera sensor. The collected AV sensor data may additionally (or alternatively) include depth information, such as depth information represented in LiDAR point cloud data collected by a LiDAR sensor on the robotic arm.

At step 310, process 300 includes identifying one or more features within the cabin based on the collected image data. Identification of various cabin features can be performed using internal (a priori) models representing the cabin and/or may be performed (or facilitated) using a machine-learning model (e.g., object classifier 212) to perform feature identification. Feature identification can also include the identification/classification of various other objects in the cabin, including but not limited to articles/debris in the cabin, and/or areas where maintenance may be needed, such as spills, stains or other problem areas, as discussed in further detail with respect to FIGS. 4 and 5, below.

At step 312, process 300 includes localizing the robotic arm within the cabin of the AV based on the one or more features identified in step 310. As discussed above, localization of the robotic arm inside the AV cabin can be performed by comparing sensor data collected at step 312 with one or more a priori models representing various features of the cabin interior. For example, differences between representations based on collected sensor data and the a priori model can be determined using an Iterative Closest Point (ICP) algorithm. Such differences can be used to determine/compute a location/pose of the robotic arm and/or tools mounted to the robotic arm, with respect to various features inside the AV.

Based on the localization of the robotic arm within the cabin, work can be performed by the arm, e.g., by activating and/or actuating various tools to perform cleaning tasks, such as vacuuming, spraying, wiping, disinfecting, and/or retrieval/removal of items from the cabin.

FIG. 4 illustrates a flow diagram of an example workflow 400 for servicing an AV, according to some aspects of the disclosed technology. Workflow 400 begins at step 402 in which a robotic arm is located/positioned within an AV cabin, as discussed above with respect to FIGS. 1-3.

At step 404 sensor data is collected by one or more sensors on the robotic arm. Collected sensor data may include camera image data and/or LiDAR data, depending on the desired implementation. For example, LiDAR data representing a depth map of the AV cabin, and one or more objects therein, may be collected and used to perform object detection (step 406). By way of example, background subtraction techniques may be used to identify objects in the AV cabin e.g., by comparing collected depth-map (LiDAR) data with a preexisting model of the AV cabin.

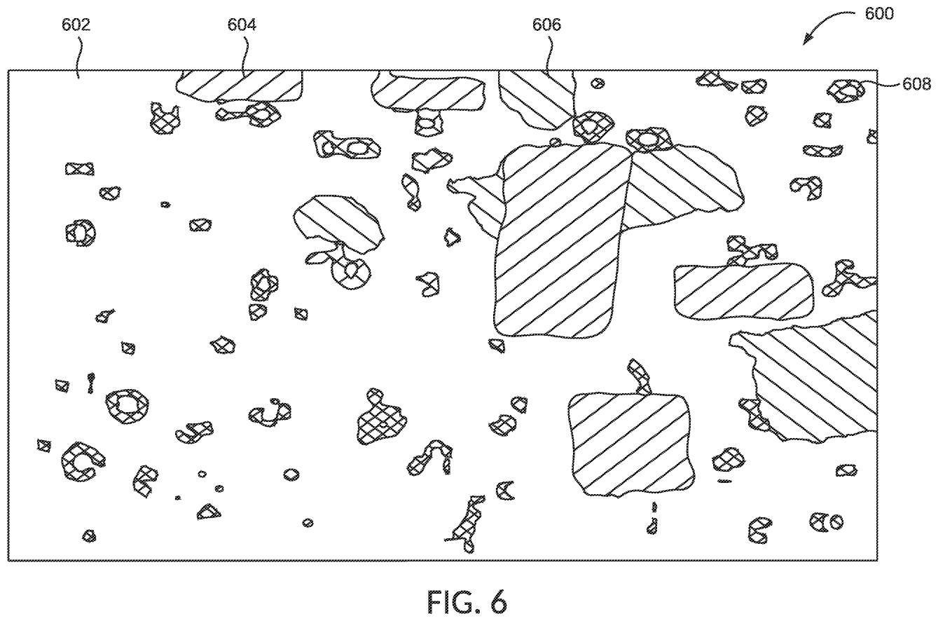

In other approaches, object detection may be performed using one or more machine-learning models. In such approaches, the collected sensor data can be provided to a machine-learning classifier and used to identify pixel regions corresponding to locations in the AV (e.g., on various surfaces, such as floors and seats) where objects may be present, as well as to classify/tag the associated image areas. For example, object detection/classification can be used to identify spills, stains, and/or other type of damage to cabin surfaces (e.g., seats, upholstery, flooring) that may need repair or maintenance, as discussed in further detail with respect to FIG. 6, below.

At step 408, it can be determined, based on the object detection/classification of step 406, if cleaning (or other work) can be performed by the robotic arm. In such instances, the determination can be based on the type of maintenance that may be required, as well as the tools available on the robotic arm. If it is determined that cleaning/work can be performed, then the workflow 400 can advance to step 410 and necessary work/cleaning can be initiated using the cleaning tools of the robotic arm. Alternatively, if it is determined that the work cannot be performed, for example, due to a large magnitude of damage (e.g., large spills, large quantities of debris, etc.), and/or due to other inadequacies of current robotic arm tooling, then workflow 400 can advance to step 412 and work order or other maintenance request can be generated. By way of example, the work order/maintenance request may alert human operators about the required maintenance. Additionally (or alternatively) the work order may provide the AV with instructions (e.g., routing instructions) indicating where necessary maintenance can be performed.

FIG. 5 illustrates a flow diagram of an example process 500 for determining if an AV cabin can be cleaned using work tools of a robotic arm. At step 502, process 500 includes collecting sensor data representing an AV cabin. The sensor data can include data collected from various types of sensors (e.g., cameras, LiDARs, etc.) that can be configured to collect sensor data relating to an environment around a robotic arm, such as robotic arm 104, discussed above. For example, the sensors data may include one or infrared camera data, such as data collected by a stereo infrared camera. Other types of sensor data also (or alternatively) be collected, without departing from the scope of the disclosed technology.

At step 504, process 500 includes identifying one or more objects represented by the sensor data. Object identification/classification can be used to determine where cleaning or other work should (and should not) be performed within the AV cabin, as discussed in further detail with respect to FIG. 6, below. Additionally, object identification/classification can be used to determine when additional maintenance or outside human intervention may be required (step 506), such as when personal items have been left in the AV, and/or when detected maintenance/cleaning issues fall outside the scope or capability of work that can be performed using robotic arm tools, such as when large items of garbage or debris may be present. In such instances, workflow processes can be triggered, e.g., to insure that the AV is routed to the proper facility or that necessary personnel are alerted to handle necessary maintenance tasks.

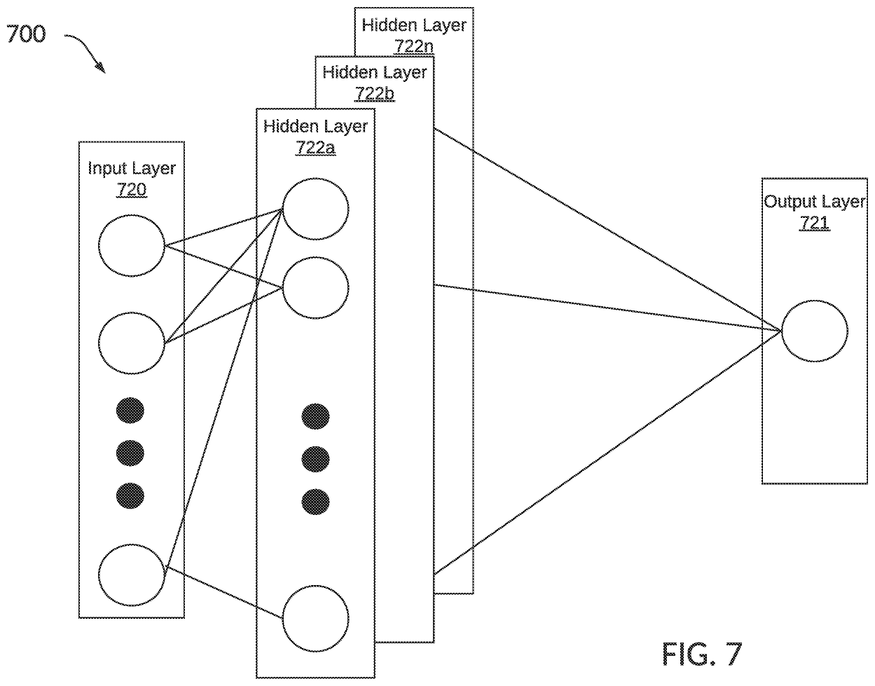

FIG. 6. illustrates an example image output 600 of a machine-learning classification model, such as deep-learning model 700, discussed in further detail with respect to FIG. 7, below. Each of the various pixel regions 602, 604, 606, and 608, in output image 600 can represent different object classifications. For example, pixel areas associated with region 602 may represent clean seat or upholstery surfaces of an AV cabin, whereas pixel regions 608 may represent stains or other damage that can be addressed using one or more tools of a robotic arm. By way of example, regions 608 may represent crumbs or light staining that can be vacuumed or wiped using tools of the robotic arm. Additionally, regions 604 and 608 may represent objects that require removal from the cabin, such as lost personal items (e.g., smart phones, wallets, articles of clothing, etc.), that may require a human operator for retrieval.

As such, using the classifications provided by output image 600, a robotic arm control system (e.g., controls module 206) can determine where work (e.g., vacuuming, spraying, wiping, etc.) should be applied with respect to AV cabin (e.g., seat surface 600), while also identifying regions where cleaning should not be performed, e.g., to items 604, 608, etc.

FIG. 7 is an illustrative example of a deep learning neural network 700 that can be implemented to perform object identification/classification, for example, to identify items in the AV cabin for cleaning/maintenance and/or for identifying AV features to facilitate robotic arm localization. An input layer 720 includes input data. In one illustrative example, the input layer 720 can be configured to receive diagnostic data associated with a given AV component, such as a camera or LiDAR sensor. The neural network 700 includes multiple hidden layers 722a, 722b, through 722n. The hidden layers 722a, 722b, through 722n include “n” number of hidden layers, where “n” is an integer greater than or equal to one. The number of hidden layers can be made to include as many layers as needed for the given application. The neural network 700 further includes an output layer 721 that provides an output resulting from the processing performed by the hidden layers 722a, 722b, through 722n.

The neural network 700 is a multi-layer neural network of interconnected nodes. Each node can represent a piece of information. Information associated with the nodes is shared among the different layers and each layer retains information as information is processed. In some cases, the neural network 700 can include a feed-forward network, in which case there are no feedback connections where outputs of the network are fed back into itself. In some cases, the neural network 700 can include a recurrent neural network, which can have loops that allow information to be carried across nodes while reading in input.

Information can be exchanged between nodes through node-to-node interconnections between the various layers. Nodes of the input layer 720 can activate a set of nodes in the first hidden layer 722a. For example, as shown, each of the input nodes of the input layer 720 is connected to each of the nodes of the first hidden layer 722a. The nodes of the first hidden layer 722a can transform the information of each input node by applying activation functions to the input node information. The information derived from the transformation can then be passed to and can activate the nodes of the next hidden layer 722b, which can perform their own designated functions. Example functions include convolutional, up-sampling, data transformation, and/or any other suitable functions. The output of the hidden layer 722b can then activate nodes of the next hidden layer, and so on. The output of the last hidden layer 722n can activate one or more nodes of the output layer 721, at which an output is provided. In some cases, while nodes (e.g., node 726) in the neural network 700 are shown as having multiple output lines, a node can have a single output and all lines shown as being output from a node represent the same output value.

In some cases, each node or interconnection between nodes can have a weight that is a set of parameters derived from the training of the neural network 700. Once the neural network 700 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 700 to be adaptive to inputs and able to learn as more and more data is processed.

The neural network 700 is pre-trained to process the features from the data in the input layer 720 using the different hidden layers 722a, 722b, through 722n in order to provide the output through the output layer 721. In some cases, the neural network 700 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training data until the neural network 700 is trained well enough so that the weights of the layers are accurately tuned.

A loss function can be used to analyze error in the output. Any suitable loss function definition can be used, such as a Cross-Entropy loss. Another example of a loss function includes the mean squared error (MSE), defined as

$$E\_total = \sum ( \frac{1}{2} {( target - output )}^{2} ) .$$

The loss can be set to be equal to the value of E_total. The goal of training is to minimize the amount of loss so that the predicted output is the same as the training label. The neural network 700 can perform a backward pass by determining which inputs (weights) most contributed to the loss of the network, and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=w_i-η dL/dW, where w denotes a weight, wi denotes the initial weight, and η denotes a learning rate. The learning rate can be set to any suitable value, with a high learning rate including larger weight updates and a lower value indicating smaller weight updates.

The neural network 700 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. The neural network 700 can include any other deep network other than a CNN, such as an autoencoder, a deep belief nets (DBNs), a Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

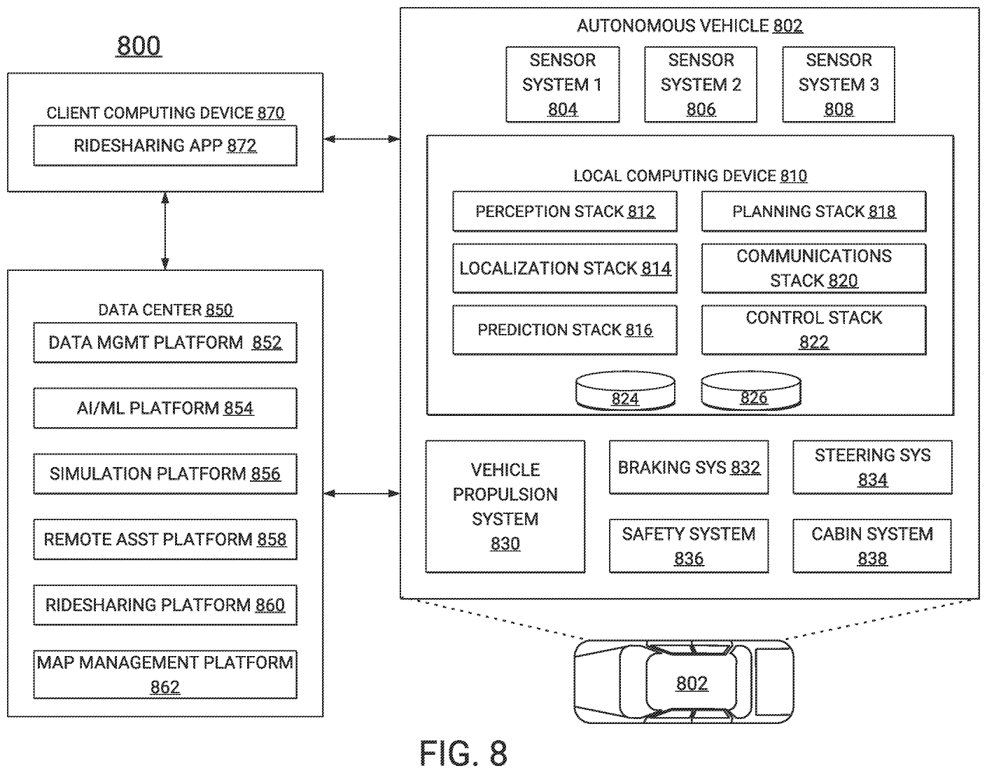

FIG. 8 illustrates an example of an AV management system 800. One of ordinary skill in the art will understand that, for the AV management system 800 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 800 includes an AV 802, a data center 850, and a client computing device 870. The AV 802, the data center 850, and the client computing device 870 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 802 can navigate roadways without a human driver based on sensor signals generated by multiple sensor systems 804, 806, and 808. The sensor systems 804-808 can include different types of sensors and can be arranged about the AV 802. For instance, the sensor systems 804-808 can comprise Inertial Measurement Units (IMUs), cameras (e.g., still image cameras, video cameras, etc.), optical sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 804 can be a camera system, the sensor system 806 can be a LIDAR system, and the sensor system 808 can be a RADAR system. Other embodiments may include any other number and type of sensors.

The AV 802 can also include several mechanical systems that can be used to maneuver or operate the AV 802. For instance, the mechanical systems can include a vehicle propulsion system 830, a braking system 832, a steering system 834, a safety system 836, and a cabin system 838, among other systems. The vehicle propulsion system 830 can include an electric motor, an internal combustion engine, or both. The braking system 832 can include an engine brake, brake pads, actuators, and/or any other suitable componentry configured to assist in decelerating the AV 802. The steering system 834 can include suitable componentry configured to control the direction of movement of the AV 802 during navigation. The safety system 836 can include lights and signal indicators, a parking brake, airbags, and so forth. The cabin system 838 can include cabin temperature control systems, in-cabin entertainment systems, and so forth. In some embodiments, the AV 802 might not include human driver actuators (e.g., steering wheel, handbrake, foot brake pedal, foot accelerator pedal, turn signal lever, window wipers, etc.) for controlling the AV 802. Instead, the cabin system 838 can include one or more client interfaces (e.g., Graphical User Interfaces (GUIs), Voice User Interfaces (VUIs), etc.) for controlling certain aspects of the mechanical systems 830-838.

The AV 802 can additionally include a local computing device 810 that is in communication with the sensor systems 804-808, the mechanical systems 830-838, the data center 850, and the client computing device 870, among other systems. The local computing device 810 can include one or more processors and memory, including instructions that can be executed by the one or more processors. The instructions can make up one or more software stacks or components responsible for controlling the AV 802; communicating with the data center 850, the client computing device 870, and other systems; receiving inputs from riders, passengers, and other entities within the AV's environment; logging metrics collected by the sensor systems 804-808; and so forth. In this example, the local computing device 810 includes a perception stack 812, a mapping and localization stack 814, a prediction stack 816, a planning stack 818, a communications stack 820, a control stack 822, an AV operational database 824, and an HD geospatial database 826, among other stacks and systems.

The perception stack 812 can enable the AV 802 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 804-808, the mapping and localization stack 814, the HD geospatial database 826, other components of the AV, and other data sources (e.g., the data center 850, the client computing device 870, third party data sources, etc.). The perception stack 812 can detect and classify objects and determine their current locations, speeds, directions, and the like. In addition, the perception stack 812 can determine the free space around the AV 802 (e.g., to maintain a safe distance from other objects, change lanes, park the AV, etc.). The perception stack 812 can also identify environmental uncertainties, such as where to look for moving objects, flag areas that may be obscured or blocked from view, and so forth. In some embodiments, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

Mapping and localization stack 814 can determine the AV's position and orientation (pose) using different methods from multiple systems (e.g., GPS, IMUs, cameras, LIDAR, RADAR, ultrasonic sensors, the HD geospatial database 826, etc.). For example, in some embodiments, AV 802 can compare sensor data captured in real-time by sensor systems 804-808 to data in HD geospatial database 826 to determine its precise (e.g., accurate to the order of a few centimeters or less) position and orientation. AV 802 can focus its search based on sensor data from one or more first sensor systems (e.g., GPS) by matching sensor data from one or more second sensor systems (e.g., LIDAR). If the mapping and localization information from one system is unavailable, AV 802 can use mapping and localization information from a redundant system and/or from remote data sources.

Prediction stack 816 can receive information from localization stack 814 and objects identified by perception stack 812 and predict a future path for the objects. In some embodiments, prediction stack 816 can output several likely paths that an object is predicted to take along with a probability associated with each path. For each predicted path, prediction stack 816 can also output a range of points along the path corresponding to a predicted location of the object along the path at future time intervals along with an expected error value for each of the points that indicates a probabilistic deviation from that point.

Planning stack 818 can determine how to maneuver or operate AV 802 safely and efficiently in its environment. For example, planning stack 818 can receive the location, speed, and direction of AV 802, geospatial data, data regarding objects sharing the road with AV 802 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 802 from one point to another and outputs from the perception stack 812, localization stack 814, and prediction stack 816. Planning stack 818 can determine multiple sets of one or more mechanical operations that AV 802 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 818 can select from multiple backup plans to carry out. For example, while preparing to change lanes to turn right at an intersection, another vehicle may aggressively cut into the destination lane, making the lane change unsafe. The planning stack 818 could have already determined an alternative plan for such an event. Upon its occurrence, it could help direct AV 802 to go around the block instead of blocking a current lane while waiting for an opening to change lanes.

Control stack 822 can manage the operation of the vehicle propulsion system 830, the braking system 832, the steering system 834, the safety system 836, and the cabin system 838. Control stack 822 can receive sensor signals from the sensor systems 804-808 as well as communicate with other stacks or components of the local computing device 810 or a remote system (e.g., the data center 850) to effectuate operation of AV 802. For example, control stack 822 can implement the final path or actions from the multiple paths or actions provided by planning stack 818. This can involve turning the routes and decisions from planning stack 818 into commands for the actuators that control the AV's steering, throttle, brake, and drive unit.

Communications stack 820 can transmit and receive signals between the various stacks and other components of AV 802 and between AV 802, data center 850, client computing device 870, and other remote systems. Communications stack 820 can enable the local computing device 810 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). Communications stack 820 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

HD geospatial database 826 can store HD maps and related data of the streets upon which the AV 802 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

AV operational database 824 can store raw AV data generated by the sensor systems 804-808, stacks 812-822, and other components of AV 802 and/or data received by AV 802 from remote systems (e.g., data center 850, client computing device 870, etc.). In some embodiments, the raw AV data can include HD LIDAR point cloud data, image data, RADAR data, GPS data, and other sensor data that data center 850 can use for creating or updating AV geospatial data or for creating simulations of situations encountered by AV 802 for future testing or training of various machine learning algorithms that are incorporated in local computing device 810.

Data center 850 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. Data center 850 can include one or more computing devices remote to local computing device 810 for managing a fleet of AVs and AV-related services. For example, in addition to managing AV 802, data center 850 may also support a ridesharing service, a delivery service, a remote/roadside assistance service, street services (e.g., street mapping, street patrol, street cleaning, street metering, parking reservation, etc.), and the like.

Data center 850 can send and receive various signals to and from AV 802 and client computing device 870. These signals can include sensor data captured by the sensor systems 804-808, roadside assistance requests, software updates, ridesharing pick-up and drop-off instructions, and so forth. In this example, data center 850 includes a data management platform 852, an Artificial Intelligence/Machine Learning (AI/ML) platform 854, a simulation platform 856, a remote assistance platform 858, and a ridesharing platform 860, and a map management platform 862, among other systems.

Data management platform 852 can be a “big data” system capable of receiving and transmitting data at high velocities (e.g., near real-time or real-time), processing a large variety of data and storing large volumes of data (e.g., terabytes, petabytes, or more of data). The varieties of data can include data having different structured (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 850 can access data stored by the data management platform 852 to provide their respective services.

AI/ML platform 854 can provide the infrastructure for training and evaluating machine learning algorithms for operating AV 802, the simulation platform 856, the remote assistance platform 858, the ridesharing platform 860, the map management platform 862, and other platforms and systems. Using the AI/ML platform 854, data scientists can prepare data sets from the data management platform 852; select, design, and train machine learning models; evaluate, refine, and deploy the models; maintain, monitor, and retrain the models; and so on.

Simulation platform 856 can enable testing and validation of the algorithms, machine learning models, neural networks, and other development efforts for AV 802, remote assistance platform 858, ridesharing platform 860, map management platform 862, and other platforms and systems. The simulation platform 856 can replicate a variety of driving environments and/or reproduce real-world scenarios from data captured by AV 802, including rendering geospatial information and road infrastructure (e.g., streets, lanes, crosswalks, traffic lights, stop signs, etc.) obtained from a cartography platform (e.g., map management platform 862); modeling the behavior of other vehicles, bicycles, pedestrians, and other dynamic elements; simulating inclement weather conditions, different traffic scenarios; and so on.

Remote assistance platform 858 can generate and transmit instructions regarding the operation of the AV 802. For example, in response to an output of the AI/ML platform 854 or other system of data center 850, remote assistance platform 858 can prepare instructions for one or more stacks or other components of AV 802.

Ridesharing platform 860 can interact with a customer of a ridesharing service via a ridesharing application 872 executing on client computing device 870. The client computing device 870 can be any type of computing system, including a server, desktop computer, laptop, tablet, smartphone, smart wearable device (e.g., smartwatch, smart eyeglasses or other Head-Mounted Display (HMD), smart ear pods, or other smart in-ear, on-ear, or over-ear device, etc.), gaming system, or other general purpose computing device for accessing ridesharing application 872. Client computing device 870 can be a customer's mobile computing device or a computing device integrated with the AV 802 (e.g., the local computing device 810). The ridesharing platform 860 can receive requests to pick up or drop off from the ridesharing application 872 and dispatch the AV 802 for the trip.

Map management platform 862 can provide a set of tools for the manipulation and management of geographic and spatial (geospatial) and related attribute data. The data management platform 852 can receive LIDAR point cloud data, image data (e.g., still image, video, etc.), RADAR data, GPS data, and other sensor data (e.g., raw data) from one or more AVs 802, Unmanned Aerial Vehicles (UAVs), satellites, third-party mapping services, and other sources of geospatially referenced data. The raw data can be processed, and map management platform 862 can render base representations (e.g., tiles (2D), bounding volumes (3D), etc.) of the AV geospatial data to enable users to view, query, label, edit, and otherwise interact with the data. Map management platform 862 can manage workflows and tasks for operating on the AV geospatial data. Map management platform 862 can control access to the AV geospatial data, including granting or limiting access to the AV geospatial data based on user-based, role-based, group-based, task-based, and other attribute-based access control mechanisms. Map management platform 862 can provide version control for the AV geospatial data, such as to track specific changes that (human or machine) map editors have made to the data and to revert changes when necessary. Map management platform 862 can administer release management of the AV geospatial data, including distributing suitable iterations of the data to different users, computing devices, AVs, and other consumers of HD maps. Map management platform 862 can provide analytics regarding the AV geospatial data and related data, such as to generate insights relating to the throughput and quality of mapping tasks.

In some embodiments, the map viewing services of map management platform 862 can be modularized and deployed as part of one or more of the platforms and systems of data center 850. For example, the AI/ML platform 854 may incorporate the map viewing services for visualizing the effectiveness of various object detection or object classification models, simulation platform 856 may incorporate the map viewing services for recreating and visualizing certain driving scenarios, remote assistance platform 858 may incorporate the map viewing services for replaying traffic incidents to facilitate and coordinate aid, ridesharing platform 860 may incorporate the map viewing services into client application 872 to enable passengers to view AV 802 in transit en route to a pick-up or drop-off location, and so on.

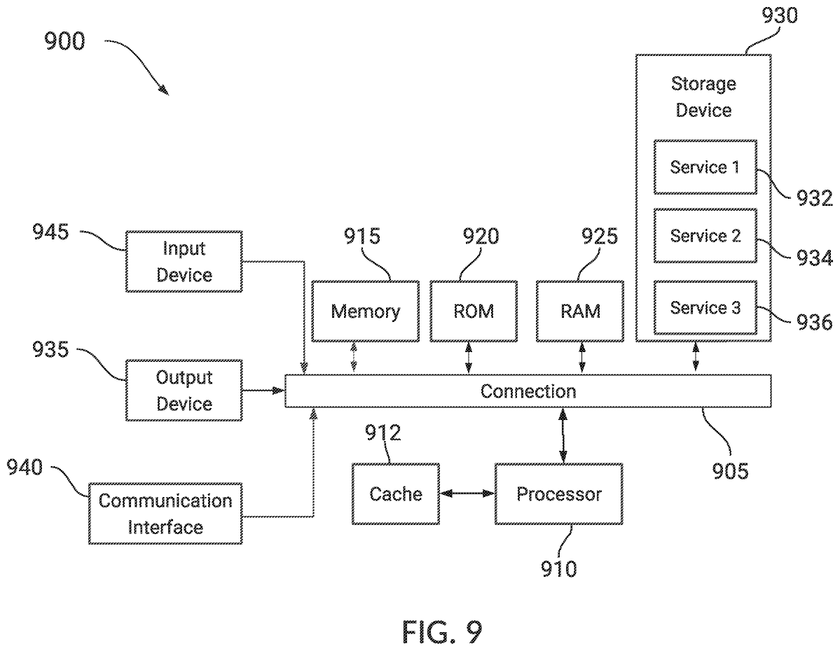

FIG. 9 illustrates an example apparatus (e.g., a processor-based system) with which some aspects of the subject technology can be implemented. For example, processor-based system 900 can be any computing device making up internal computing system 810, remote computing system 850, a passenger device executing the rideshare app 870, or any component thereof in which the components of the system are in communication with each other using connection 905. Connection 905 can be a physical connection via a bus, or a direct connection into processor 910, such as in a chipset architecture. Connection 905 can also be a virtual connection, networked connection, or logical connection.

Computing system 900 can be (or may include) a distributed system in which the functions described in this disclosure can be distributed within a datacenter, multiple data centers, a peer network, etc. In some embodiments, one or more of the described system components represents many such components each performing some or all of the functions for which the component is described. In some embodiments, the components can be physical or virtual devices.

Example system 900 includes at least one processing unit (CPU or processor) 910 and connection 905 that couples various system components including system memory 915, such as read-only memory (ROM) 920 and random-access memory (RAM) 925 to processor 910. Computing system 900 can include a cache of high-speed memory 912 connected directly with, in close proximity to, or integrated as part of processor 910.

Processor 910 can include any general-purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms known to those of skill in the art. In some instances, multimodal systems can enable a user to provide multiple types of input/output to communicate with computing system 900. Computing system 900 can include communications interface 940, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communication interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a Blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L6), resistive random-access memory (RRAM/ReRAM), phase change memory (PCM), spin transfer torque RAM (STT-RAM), another memory chip or cartridge, and/or a combination thereof.

Storage device 930 can include software services, servers, services, etc., that when the code that defines such software is executed by the processor 910, it causes the system to perform a function. In some embodiments, a hardware service that performs a particular function can include the software component stored in a computer-readable medium in connection with the necessary hardware components, such as processor 910, connection 905, output device 935, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

What is claimed is:

1. An apparatus for performing object detection, comprising:
at least one memory; and
at least one processor coupled to the at least one memory, the at least one processor configured to:
collect sensor data representing a cabin of an autonomous vehicle (AV) using an optical sensor disposed on a robotic arm;
identify one or more objects represented by the sensor data; and
determine if the cabin of the AV can be cleaned using one or more tools associated with the robotic arm based on an identification of at least one of the one or more objects.

2. The apparatus of claim 1, wherein to identify the one or more objects, the at least one processor is configured to:
classify the one or more object using a machine-learning model.

3. The apparatus of claim 1, wherein to identify the one or more objects the at least one processor is configured to:
compare the collected sensor data to a pre-existing model representing the cabin of the AV.

4. The apparatus of claim 1, wherein the at least one processor is further configured to:
activate at least one of the one or more tools associated with the robotic arm to initiate cleaning on the cabin of the AV, if it is determined that the cabin of the AV can be cleaned using the one or more tools associated with the robotic arm.

5. The apparatus of claim 1, wherein the at least one processor is further configured to:
generate a work order to request additional maintenance for the AV, if it is determined that the cabin of the AV cannot be cleaned using the one or more tools associated with the robotic arm.

6. The apparatus of claim 1, wherein the sensor data comprises camera image data.

7. The apparatus of claim 1, wherein the sensor data comprises Light Detection and Ranging (LiDAR) point cloud data.

8. A computer-implemented method, comprising:
collecting sensor data representing a cabin of an autonomous vehicle (AV) using an optical sensor disposed on a robotic arm;
identifying one or more objects represented by the sensor data; and
determining if the cabin of the AV can be cleaned using one or more tools associated with the robotic arm based on an identification of at least one of the one or more objects.

9. The computer-implemented method of claim 8, wherein to identify the one or more objects, the at least one processor is configured to:
classify the one or more object using a machine-learning model.

10. The computer-implemented method of claim 8, wherein identifying the one or more objects further comprises:
comparing the collected sensor data to a pre-existing model representing the cabin of the AV.

11. The computer-implemented method of claim 8, further comprising:
activating at least one of the one or more tools associated with the robotic arm to initiate cleaning on the cabin of the AV, if it is determined that the cabin of the AV can be cleaned using the one or more tools associated with the robotic arm.

12. The computer-implemented method of claim 8, further comprising:
generating a work order to request additional maintenance for the AV, if it is determined that the cabin of the AV cannot be cleaned using the one or more tools associated with the robotic arm.

13. The computer-implemented method of claim 8, wherein the sensor data comprises camera image data.

14. The computer-implemented method of claim 8, wherein the sensor data comprises Light Detection and Ranging (LiDAR) point cloud data.

15. A non-transitory computer-readable storage medium comprising at least one instruction for causing a computer or processor to:
collect sensor data representing a cabin of an autonomous vehicle (AV) using an optical sensor disposed on a robotic arm;
identify one or more objects represented by the sensor data; and
determine if the cabin of the AV can be cleaned using one or more tools associated with the robotic arm based on an identification of at least one of the one or more objects.

16. The non-transitory computer-readable storage medium of claim 15, wherein to identify the one or more objects, the at least one instruction is further configured to cause the computer or processor to:
classify the one or more object using a machine-learning model.

17. The non-transitory computer-readable storage medium of claim 15, wherein to identify the one or more objects the at least one instruction is further configured to cause the computer or processor to:
compare the collected sensor data to a pre-existing model representing the cabin of the AV.

18. The non-transitory computer-readable storage medium of claim 15, wherein the at least one instruction is further configured to cause the computer or processor to:
activate at least one of the one or more tools associated with the robotic arm to initiate cleaning on the cabin of the AV, if it is determined that the cabin of the AV can be cleaned using the one or more tools associated with the robotic arm.

19. The non-transitory computer-readable storage medium of claim 15, wherein the at least one instruction is further configured to cause the computer or processor to:
generate a work order to request additional maintenance for the AV, if it is determined that the cabin of the AV cannot be cleaned using the one or more tools associated with the robotic arm.

20. The non-transitory computer-readable storage medium of claim 15, wherein the sensor data comprises camera image data, Light Detection and Ranging (LiDAR) point cloud data, or a combination thereof.
